(19) United States
(12) Patent Application Publication
(10) Pub. No.: US 2016/0092906 A1
(43) Pub. Date: Mar. 31, 2016

(54) Systems and Methods for Providing a Commerce Discount Card

(71) Applicant: Dominic Gerard CIOFFI, Sparta, NJ (US)

(72) Inventor: Dominic Gerard CIOFFI, Sparta, NJ (US)

(73) Assignee: GRADES COUNT LLC, Sparta, NJ (US)

(21) Appl. No.: 14/865,254

(22) Filed: Sep. 25, 2015

Related U.S. Application Data
(60) Provisional application No. 62/056,318, filed on Sep. 26, 2014.
(60) Provisional application No. 62/138,946, filed on Mar. 26, 2015.

(51) Int. Cl. G06Q 30/02; G06Q 50/20; G06Q 20/34

(52) U.S. Cl. CPC G06Q 30/0236; G06Q 30/0239; G06Q 30/0273; G06Q 20/342; G06Q 50/20

(57) ABSTRACT

Method and system for incentivizing student achievement and teacher performance by maintaining a database of students and their attributes, providing teachers access to update the attributes, and permitting businesses to offer attribute-related incentives to the students and teachers, but only when the student qualifies for the incentive based on their attributes or the teacher qualifies for the incentive based on the attributes of their students. Each student interacts with an incentive database to obtain a list of the available incentives. Each business interacts with the database and upon providing an identification of a student seeking an incentive, receives an indication of whether the student qualifies for an offered incentive. If so, the student is able to use the incentive.

### CLAIM TO PRIOR APPLICATIONS

This application claims the benefit of U.S. provisional patent application Ser. No. 62/056,318 filed Sep. 26, 2014 and U.S. provisional patent application Ser. No. 62/138,946 filed Mar. 26, 2015, both of which are incorporated by reference herein in their entirety.

### BACKGROUND OF THE INVENTION

Embodiments of the present invention generally relate to systems and methods for providing a commerce discount card. More specifically, the present invention relates to systems and methods for providing a commerce discount card and incentive program that are directly connected to a student's grade point average (GPA).

Existing known commerce discount cards either do not track anything and only provide an incentive for shopping at an issuing and/or participating business or track expenditures and purchases at issuing and/or participating businesses. This does not permit the use of such commerce discount cards to incentivize non-shopping behaviors including, but not limited to, school attendance, school performance, community and/or extracurricular activity participation, good citizenship and/or other laudable or desirable behaviors.

Existing incentive schemes for encouraging laudable or desirable behaviors such as, without restriction, school attendance, school performance, good citizenship, and/or community and/or extracurricular activity participation, are often limited in scope and/or incentive, allowing the program to only incentivize particular grades when grades are issued or when the activity terminates. Further, currently known incentive programs do not return other benefits to the schools or organizations participating. Such incentive programs typically issue a monetary or merchandise reward (e.g. a pizza) as a reward for particular grade thresholds (e.g. a pizza for at least one “A” grade or a specified amount of money for each grade greater than a “C” received by a student). Existing incentive programs generally do not enable a community and/or specific businesses in the community to provide specific and/or granular incentives for grade improvement, total grade average and/or other criteria.

The present invention solves these problems and provides a new system that allows tailored incentives and promotions that encourage academic performance, provide marketing opportunities to businesses, and/or return money to participating schools.

### BRIEF SUMMARY OF THE INVENTION

In one embodiment of the present invention, systems and methods are provided for providing a commerce discount card.

In another embodiment of the present invention, systems and methods are provided for a combined incentive and marketing program.

In another embodiment of the present invention, the systems and methods include user savings and/or investment accounts.

In all embodiments of the invention, the discount card, incentive and marketing program and/or savings and/or investment accounts are linked to user attributes which may be, inter alia, a student's grade point average, attendance, participation and/or any other attribute connected to or reflecting academic, scholastic, and/or community participation, effort, and/or achievement.

In one method for incentivizing student achievement in accordance with the invention, a database of students and their attributes is maintained, teachers are provided with access to an online system for providing input on the student attributes, the database is updated on the input from the teachers, and businesses are permitted to offer incentives to the students. Each student may only utilize an incentive based on a specific attribute specified by the business, the specific attribute being based on the attribute of the student, e.g., a business specifies an incentive based on GPA and the student's GPA is maintained in the database. Then, a database of incentives provided by the businesses is maintained, each student can interact with the incentive database using the online system and as a result of the interaction, obtain a list of the available incentives. Each business interacts with the student attribute database using the online system and provides an identification of a student seeking an incentive from the business in response to the provided identification, receives, in the affirmative or negative, a response as to whether a particular student seeking an incentive has the specific attribute for a particular incentive offered by the business.

The method may also entail determining a fee to collect from each business based on interaction of the business with the online system and then collecting the determined fee from the business. The fee may be collected from the business providing incentives, i.e., based on the incentive provided regardless of whether they are utilized, for example, as a percentage of the value of the incentive. The fee may additionally or alternatively be collected from the businesses based on the use of the incentives by the students.

In one embodiment, each student is provided with an identification or identifying device and each business is provided with a secured data link device capable of interfacing with the identification device and connecting to the online system. As such, responding to the business entails interfacing or interacting the particular student's identification device with the business's secured data link device, and as result of this interfacing, the response relating to available incentives offered by the business for which the student qualifies is provided to the business, e.g., on a display screen of the secured data link device and/or otherwise visually and/or orally conveyed to the business and/or student. This available incentive is thus displayed on a presentation device to the business, or vocalized using an incentive presentation device.

As to the availability of teacher incentives, the method entails maintaining a database of teachers and their teacher attributes, and permitting each business to offer at least one teacher incentive to the teachers, each teacher may only utilize a teacher incentive based on a specific teacher attribute specified by the business which might, but is not required to, relate to the performance of their students, A database of teacher incentives provided by the businesses is maintained and a list of the teacher incentives may be provided to the teachers through the online system. When the teachers interact with the business, via use of a teach identification system and business's secured data link device, a response is provided to the business, e.g., in the affirmative or negative, whether a particular teacher has the specific attribute for a particular incentive.

In another embodiment, a first group of students is designated as mentor candidates based on their attributes, a second group of students is designated as mentee candidates based on their attributes, and, using a processor, at least one mentor candidate is matched with at least one mentee candidate. Attributes of the mentor candidates may be altered based on changes in the attributes of the mentee candidates matched therewith, e.g., grade improvement.

A student incentive system in accordance with the invention includes a student database containing a plurality of student records, each student records comprising a student identifier and at least two student attributes, an incentive database containing a plurality of incentive offers, each incentive offer comprising an incentive offered by a business and an attribute required for the incentive, and an online system comprising a first interface providing access to the student database, a second interface providing access to the incentive database, and a verification interface that, when provided an incentive offer and a student identifier, determines using the first and second interfaces, if the student identified by the student identifier has the attribute required for the incentive of the incentive offer.

business offering at least one incentive;

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a block diagram of a preferred embodiment of the incentive system in accordance with the invention;

FIG. 2 is a block diagram of a database entry of student attributes in accordance with the invention;

FIG. 3 is a front view of a preferred embodiment of a card issued to a participating student in accordance with the invention;

FIG. 4 is a flow chart of the one method of operation of the incentive system in accordance with the invention;

FIG. 5 is a block diagram of portion of the incentive system relating to financial institutions in accordance with the invention;

FIG. 6 is a block diagram of one embodiment of a mentorship system in accordance with the invention;

FIG. 7 is a block diagram of a second embodiment of the mentorship system in accordance with the invention; and

FIG. 8 is a flow chart of a method of operation of the incentive systems in accordance with the invention that additionally provides incentives to teachers.

### DETAILED DESCRIPTION OF THE INVENTION

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a server” may include a plurality of servers. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

Disclosed herein is a real time GPA incentive system (the “incentive system”), and methods for implementing and operating the incentive system, that is directly connected to a plurality of attributes of a plurality of students including, without restriction, each student's grades within the school that student is attending. As part of the incentive system, students are offered incentives such as, without restriction, discounts, bonuses, goods and services, monetary payments, and/or access to other benefits from businesses including retailers, banks and financial institutions, transportation companies, and any other business or concern choosing to participate.

The incentive system may be implemented on a school level, a district level, a state level, and/or nationally. Herein, the term “school” is used to refer to the participating entity and “teacher” is used to refer to instructors, but the participating entity may be any educational institution including postsecondary, professional, and/or trade education institutions and may be any number of such institutions, such as a school district implementing the incentive system in all schools in the district or a national school network implementing the incentive system in all schools in the network.

The incentive system is intended to help all children and young adults understand the value of working hard while in school and the rewards that come with it, not only for their future, but for the present while they are students; help a stagnant and sluggish economy grow rapidly; and/or help the nation's academic reputation which has declined dramatically over the years compared to the rest of the world.

Additional benefits of the present invention include: students are empowered, self-motivated and incentivized to work harder in school to keep their grades up; merchants, banks and the economy benefit greatly from the increase in sales year round, simply by offering the incentive to millions of elementary, high school, undergraduate and graduate students registered with the program; registered students can earn scholarship funds based on their consistent and continued participation in the incentive program and academic success.

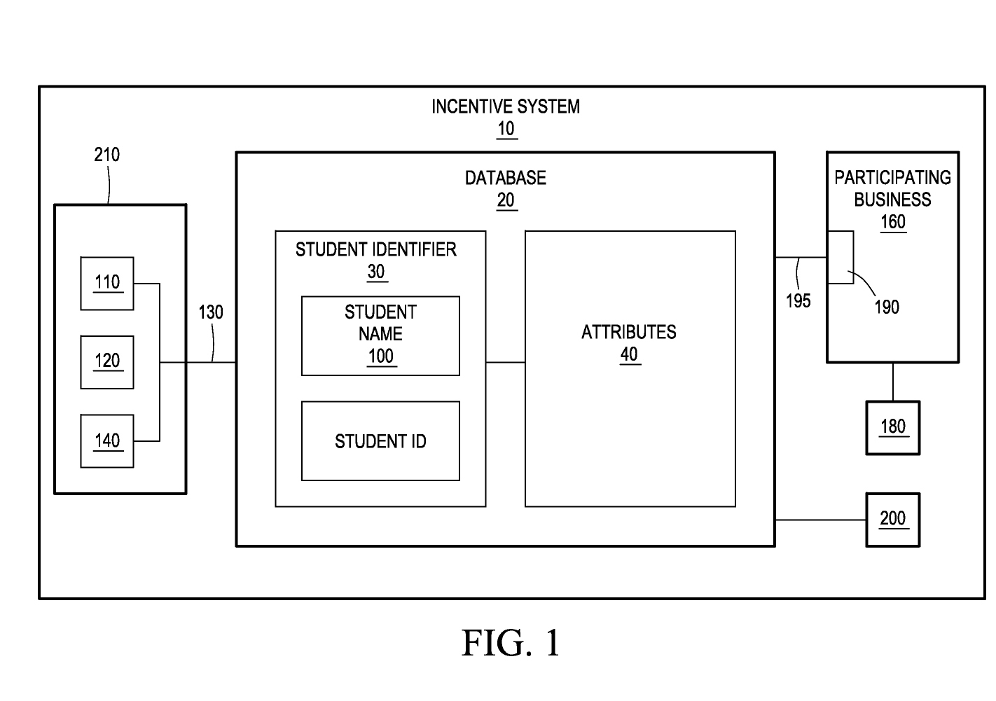

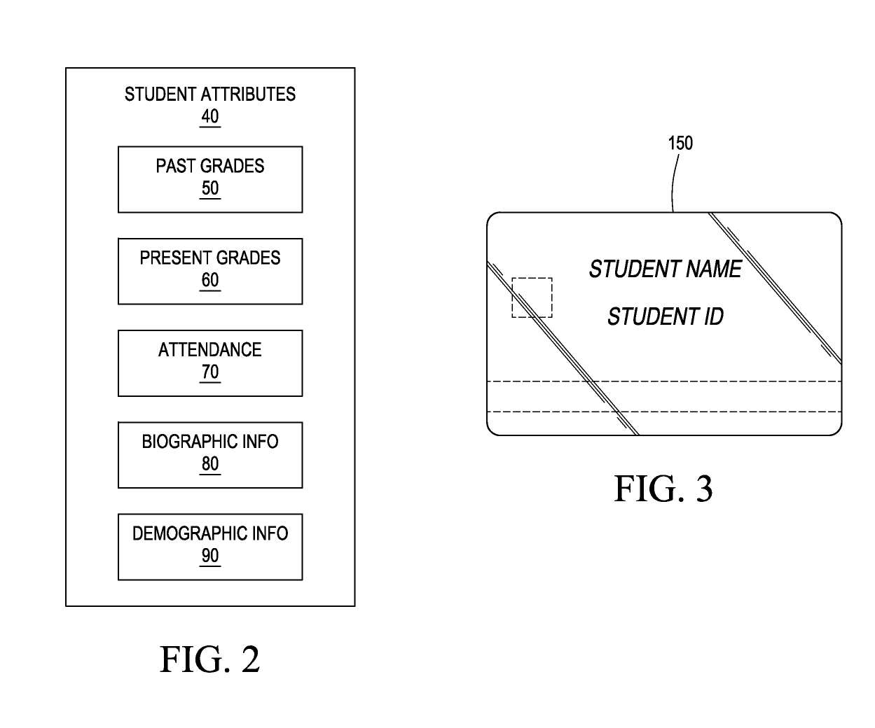

In a first embodiment, as depicted in FIG. 1, an incentive system in accordance with the invention is generally designated 10 and comprises a central database 20 of student identifiers 30 and student attributes 40 linked to each identifier. Central database 20 does not have to be a single database and when used herein represents one or more data storage components that may be co-located or located at different locations and interconnected to, in combination, form the central database 20. Student identifiers 30 refer to registered students 100 and may be, without restriction, the name of the student 100, and/or an identification number assigned by a participating school 210 or other organization to the student 100. Each student identifier 30 is unique to a registered student 100 and uniquely identifies that student 100. Student attributes 40, as shown in FIG. 2, may be any information about the student 100 stored in the central database 20 and may include, without restriction, past grades 50, present grades 60, attendance records 70, biographic information 80, demographic information 90, and/or information regarding extracurricular and athletic participation by the student 100. The student attributes 40 of each student 100 are linked to that student's student identifier 30.

Student attributes 40 may be updated when the student 100 receives new grades 60 or otherwise changes the attribute 40. Such update may be performed directly by a registered teacher 110 or administrator 120 or may be automatic and/or triggered by a connection 130 to a school database 140. Connection 130 may be continuously active, active on a preset schedule or activated based on an update to school database 140. Connection 130 may be, without restriction, a direct connection, a connection via an internet protocol, preferably http, or any other connection capable of transferring data between school database 140 and central database 20. Generally, the connection 130 represents connecting means for connecting the participating school 210 to the central database 20, such connecting means being any known structure for connecting two electronic components together for data transfer. Updates may be entered directly into central database 20 by a registered teacher 110 or administrator 120 or may be entered into the school database 140 and transferred to the central database 20 via the connection 130.

One or more participating schools 210 and respective school databases 140 may be connected to one central database 20 and/or more than one central database 20 may be operated, to provide redundancy or otherwise improve the functionality of incentive program 10.

When a participating school 210 joins or implements the incentive system 10, a school database 140 is created and linked with the central database 20. The school database 140 may be located at the same data storage facility as the central database 20, or separate therefrom. The school database 140 is created along with at least one registered teacher 110 or administrator 120 (see FIG. 1). A registered teacher 110 or administrator 120 may add additional registered teacher s 110 or administrators 120. A registered teacher 110 or administrator 120 may also add a list of eligible students 95 to the school database 140. Eligible students 95 may then register as participating students 100. Participating students 100 are herein referred to as students 100 or participating students 100. Eligible student 95 refers to a student at a participating school 210 that has not yet registered in the incentive system 10.

A registered teacher 110 or administrator 120 may enter student attributes 40 of an eligible student 95 and may assign a student identifier 30 to an eligible student 95. Alternatively, the incentive system 10 may notify an appropriate registered teacher 110 or administrator 120 when an eligible student 95 registers as a participating student 100 and prompt the registered teacher 110 or administrator 120 to enter the student attributes 40 of the now-participating student 100 in the school database 140. Additionally, the incentive program 10 may generate a student identifier 30 for a student 100 upon registration if a student identifier 30 was not entered for the eligible student 95.

Upon registration, each student 100 receives a program token 150 containing their student identifier 30. The program token 150 may be any object or software embodied in an object or a graphic representation printed on an object (bar code, QR code) capable of carrying a student identifier 30, including, without restriction, a card with an identifying number and/or a magnetic strip as in a standard credit or debit card, a card with an RFID chip or smart chip, a smartphone app, or a card or fob including any of the foregoing and/or a machine-readable and/or human-readable visual representation, storage, and/or other medium storing, encoding and/or representing the student identifier 30. Said program token 150 is preferably a card with a magnetic stripe and is referred to herein as a card 150 (see FIG. 3), but this usage does not imply that the incentive program 10 is restricted to use with a card. Other program tokens 150 contemplated for use in the present invention include, without restriction, QR codes either printed or stored on a student 100's mobile device, NFC or RFID identifiers stored on a special-purpose device or stored on a student 100's mobile device, and account numbers that can be memorized, stored in a mobile device, printed or written on a membership card, and/or otherwise retained by a student 100 and made to correspond with a student identifier 30.

A business choosing to participate in the incentive program 10 is registered as a participating business 160 (see FIG. 1). Participating businesses 160 may define or create one or more particular incentives 170 offered to students 100. Such incentives 170 may be, without restriction, discounts, rebates, monetary awards, contest entries, free and/or discounted goods and/or services, charitable donations, promotional items, access to limited-stock items, and/or any other type of incentive the participating business 160 chooses to offer in connection with the incentive system 10.

Participating businesses 160 may choose to restrict and/or offer particular incentives 170 based on one or more student attributes 40. For example, a business 160 may choose to offer a graduated discount to students 100 based on an average of their present grades 60, offering a 5% discount on goods or services to a student 100 with an average grade 60, on a 4.0 GPA scale, of greater than or equal to 3.0 and less than 3.5, a 10% discount to a student 100 with an average grade 60, on a 4.0 GPA scale, of greater than or equal to 3.5 and less than 4.0, and a 15% discount to a student 100 with an average grade 60, on a 4.0 GPA scale, of greater than or equal to 4.0 Participating businesses 160 may designate such incentives 170 based on any combination(s) of student attributes 40, and possibly other attributes including but not limited to the time of day, weather, season, semester, etc.

A participating business 160 is equipped with a secured data link device 180 configured to identify the student 100 based on the program token 150 and equipped with a communication system 190, capable of connecting to the central database 20. The communication system 190 may be, without restriction, a modem, wireless radio or any other system capable of connecting remotely to the central database 20. In a preferred embodiment, the communication system 190 utilizes an encrypted connection 195 via the internet or other wired or wireless network. In one embodiment, a secured data link 180 device is provided to each participating business 160 and interacts with the program token 150, e.g., optically or magnetically reads the data on the card.

In addition to the foregoing, the system includes an online interface 200. The online interface 200 may be a web interface, a mobile app interface and/or any other interface capable of allowing students 100, registered teachers 110, registered administrators 120, and/or participating businesses 160 to access relevant portions of the central database 20. The online interface 200 permits students 100 to check their current student attributes 40; registered teachers 110 and/or registered administrators 120 to add new students 100 and/or update student attributes 40; and participating businesses 160 to create new incentives 170, update or modify existing incentives 170 and/or check the status and success of existing and/or past incentives 170. Additionally, the online interface 200 may allow registered teachers 110, registered administrators 120 and/or participating businesses 160 to make and/or receive payments of fees 165, funds, and/or awards tied to the incentive program 10.

In a preferred method of operation of incentive system 10, an operating organization 250 operates one or more central databases 20, and servers that manage the central databases 20, and coordinates with one or more participating schools 210, and one or more participating businesses 160. The term participating school is used herein to mean an educational or community organization of any size and serving any population. For example, a participating school 210 may be, without restriction, an elementary school, a high school, a community college, a university, an adult education program, a school district comprised of two or more schools, or a county, state, regional and/or national organization comprised of two or more schools. Each participating school 210 designates at least one teacher 110 and/or administrator 120. Such designated teachers 110 and administrators 120 are also referred to herein as registered teachers 110 and registered administrators 120. A participating school 210 also provides the operating organization 250 with names of students 100 attending or otherwise affiliated with the participating school 210. Participating school 210 may also provide a student identifier 30 tied to each student 100, student biographical data 270 for each student 100, and/or student attributes 40 for each student 100. Student identifiers 30 may be generated by the operating organization 250 for each student 100, student biographical data 270 may be entered at a later time by the student 100 or by registered teachers 110 and/or registered administrators 120, and/or student attributes 40 for each student 100 may be entered at a later time by the student 100 or by registered teachers 110 and/or registered administrators 120. Registered teachers 110 and/or registered administrators 120 may update student attributes 40 at any time, and student attributes 40 are stored in the central database 20 and updated promptly after such updates are submitted.

Students 100 may register for the incentive program 10 using the online interface 200. Upon registration, a student 100 creates an account and username 280 which may be the same as their student identifier 30. The student 100 is matched against the list of students provided by a participating school 210 and paired with any student attributes 40 and/or biographical data 270 entered by registered teachers 110 and/or registered administrators 120. The student identifier 30 is linked to student attributes 40 and/or biographical data 270 contained in the central database 20.

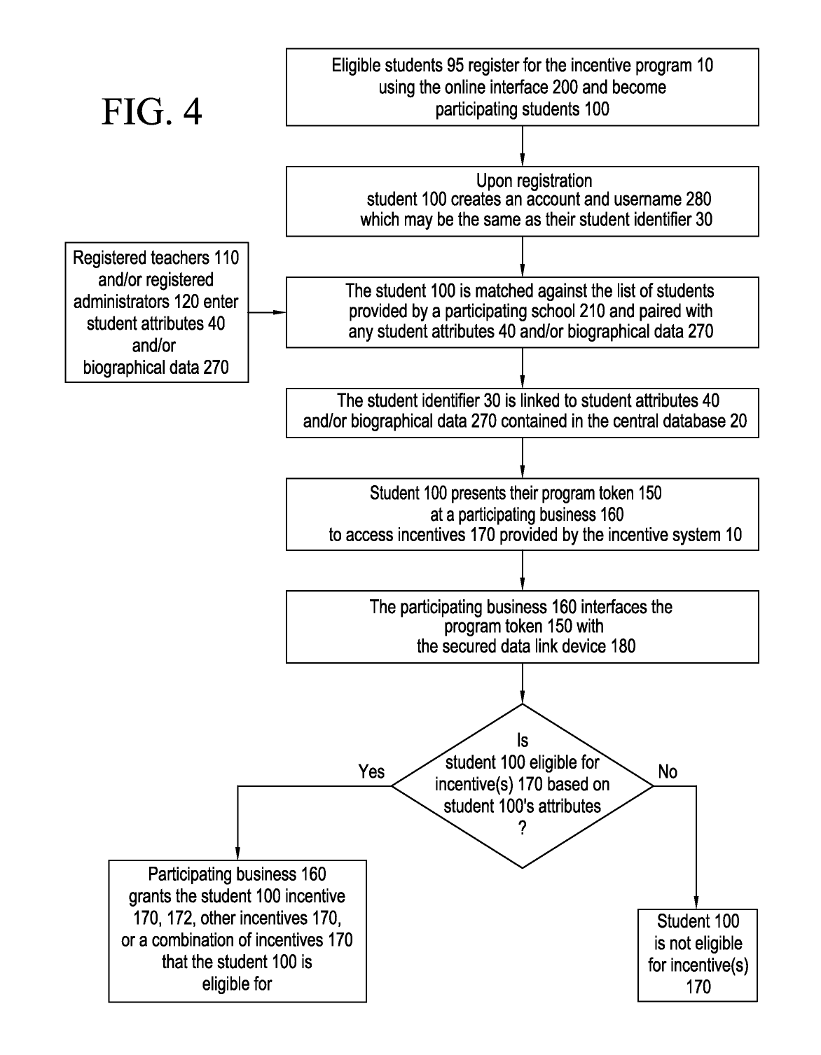

To access incentives 170 provided by the incentive system 10, each student 100 presents their program token 150 at a participating business 160 (see FIG. 4). The participating business 160 then interfaces the program token 150 with the secured data link device 180. The student identifier 30 is then transmitted to the central database 20, which transmits back which, if any, incentive(s) 170 offered by the participating business 160 the student 100 is eligible for based on the student's attribute(s) 40. A student 100 may be eligible for a first incentive 171, a second incentive 172, other incentives 170, any combination of incentives 170, or no incentive. The participating business 160 then grants the student 100 one or more incentives 170 that the student 100 is eligible for.

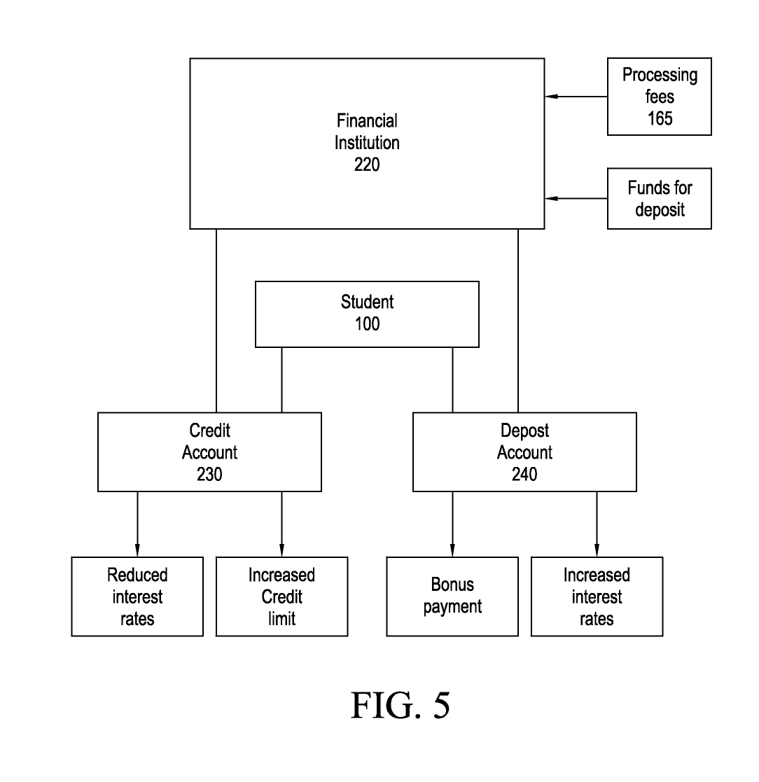

Certain embodiments of the incentive system 10 may include participation by one or more financial institution(s) 220 (see FIG. 5). Such financial institutions 220 may be, without restriction, credit card issuers, credit card processors, banks, credit unions, community banks, internet payment providers such as PayPal® or Square®, and/or digital currency processors such as Bitcoin service providers or depositories.

Financial institutions 220 may participate in the incentive system 10 in multiple ways. In one embodiment, the financial institution 220 offers a credit account 230 and/or deposit account 240 to participating students 100. The financial institution 220 may offer incentives 170 linked to these accounts, such as reduced interest rates or increased limits on a credit account 230 or bonus payments or increased interest rates on a deposit account 240. For example, the financial institution 220 may offer a monetary payment deposited directly in the deposit account 240 to any student 100 with an average grade 60 above a pre-determined threshold. The financial institution 220 may offer other incentives 170 such as improved interest rates or terms on college tuition loans.

When there is a participating financial institution 220, it may be, but is not required to be, the processor of any fees 165 collected from participating businesses 160. It may also be, but is not required to be, the depository of any funds collected for distribution to participating schools 210 and/or as scholarships.

Optionally, the incentive system 10 may further include charging the participating business 160 a fee 165 for participation in the incentive program 10 (see FIG. 5). Such a fee 165 may be assessed on a transaction basis or a membership basis. If assessed on a transaction basis, it may be assessed at a flat rate per transaction or on a percentage basis for each transaction. Similarly, if the fee 165 is assessed on a membership basis, the amount of the fee 165 may vary based on the number of transactions, amount of transactions, or size of a participating business 160. The fee 165 may be divided among the operating organization 250, the student's school 210, one or more financial institutions (such as participating financial institutions 220) and/or other organizations participating in and/or enabling the incentive system 10. The particular division of the fee 165 is customized based on the needs of the community in which the incentive system 10 operates and agreement among the participating schools 210 and businesses 160. Each participating business 160 may arrange for a specific fee 165 and different divisions of the fee 165 among recipients of the fee 165. For example, in a preferred embodiment of the incentive program 10, the fee 165 is divided so that 50% of the fee 165 is paid to the participating school 210 and 50% is retained by the operating organization 250. In another embodiment of the incentive program 10, a portion of the fee is deposited in a scholarship fund, this fund being either earmarked for the student 100 making the transaction resulting in the fee and/or for distribution among participating students 100.

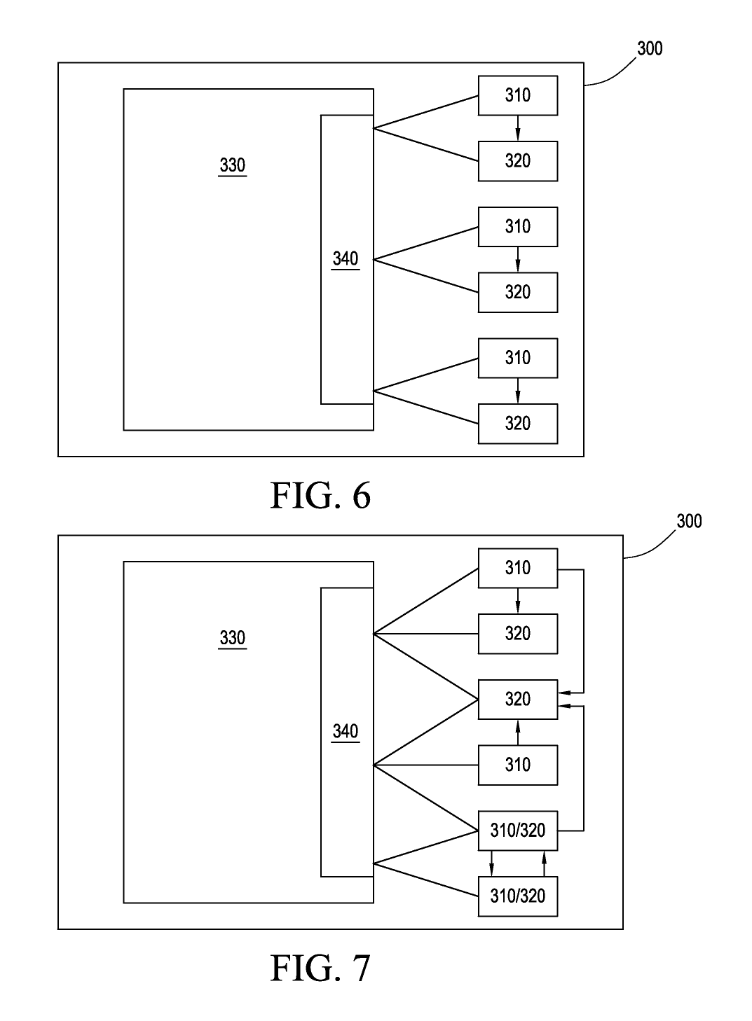

Additionally, some embodiments of the incentive program 10 include a mentorship program 300 (see FIGS. 6 and 7). The mentorship program 300 connects at least one mentor student 310 with at least one mentee student 320. Each mentor student 310 is a registered student 100 and may be of any age. Each mentee student 320 is a registered student 100 and may be of any age. Students 100 qualify to be mentor students 310 and/or mentee students 320 based on their student attributes 40. Any student may be either or both a mentor student 310 and a mentee student 320. For example, in one embodiment of the mentorship program 300, a student 100 is qualified to be a mentor student 310 in a particular academic subject if their grade 60 in this subject is an A or better or a mentee student 320 if their grade 60 in this subject is a C or worse. In such an embodiment, a student 100 receiving an A in a first subject and a C in a second subject would qualify as a mentor student 310 in the first subject and as a mentee student in the second subject.

In embodiments including a mentorship program 300, the online interface 200 includes a mentor matching system 330 that matches students 100 qualified to be mentor students 310 with students 100 qualified to be mentee students 320, using a computer with a processor that is configured to match using desired qualities or characteristics or two students seeking to be matched. The mentor matching system 330 may further match students 100 based on their student attributes 40. As depicted in FIGS. 6 and 7, the mentorship program includes mentor students 310 and mentee students 320, with the direction of the arrows between mentor students 310 and mentee students 320 showing the mentorship relationship. Note that FIG. 7 includes students who are both mentor students 310 and mentee students 320, denoted as 310/320, as well as mentorship relationships where multiple mentor students 310 mentor one mentee student 320 and where a single mentor student 310 mentors multiple mentee students. The mentor matching system 330 may further include communications means 340 for use by students 100 to allow one or more mentor students 310 to communicate with mentee students 320. Such communications means 340 may include, without restriction, text chat systems, voice over IP (VOIP) systems, video chat systems and/or bulletin board systems. Generally, communication means are structure that enable two people to communicate with one another.

Participating businesses 160 and/or participating schools 210 may offer incentives 170 to student mentors 310 and student mentees 320. In particular, a preferred embodiment of the mentorship system 300 provides incentives 170 to student mentors 310 who mentor student mentees 320 who thereafter show improvement in one or more student attributes 40, specifically grades 60.

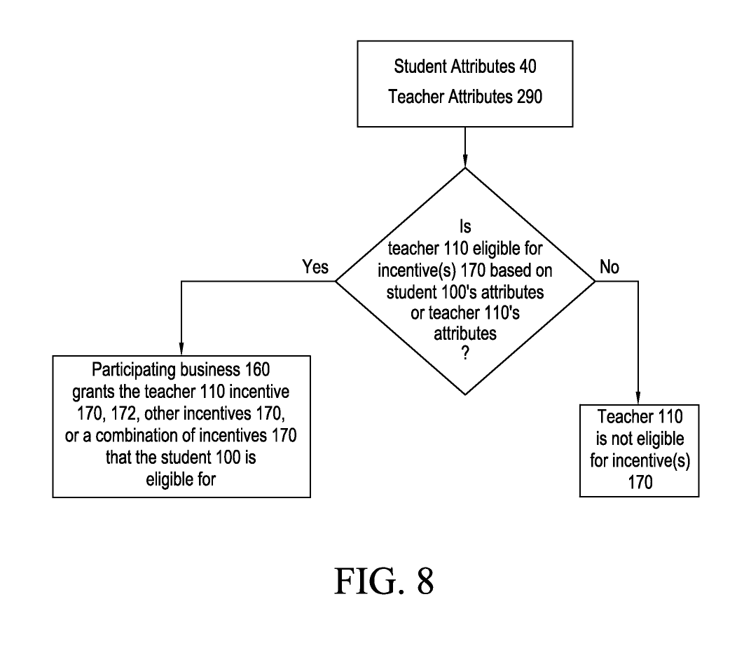

In addition to allowing participating businesses 160 and/or participating schools 210 to provide incentives 170 to students 100, the incentive system 10 may allow participating businesses 160 and/or participating schools 210 to provide incentives 170 to registered teachers 110 (see FIG. 8). Such incentives 170 may be based on the student attributes 40 of students 100 instructed by the teacher 110 or may be based on teacher attributes 290. Such teacher attributes 290 may include values derived from student attributes 40 or may include such values as, without restriction, the time the teacher 110 takes to grade student work, additional tutoring undertaken by the teacher 110 or other desirable acts or attributes of the teacher 110. The teacher attributes 290 may be stored in the central database 20 or in the school database 140, or possibly in a separate teacher attribute database. The administrators 120 may access this database and provide information about the teachers 110. Similarly, the businesses 160 may be provided with parameters of the teacher attributes to enable them to determine incentives to offer to the teachers 110. The manner in which the teachers 110 would receive incentives form the participating businesses 160 is the same as the students 100, i.e., using teacher identifying device, similar to the program token 150, but coded for the teachers. The businesses would interface with the teacher database to determine teacher incentives when the teacher identifying devices are presented.

Although the present invention has been described in relation to particular embodiments thereof, many other variations and modifications and other uses may become apparent to those skilled in the art. It is preferred, therefore, that the present invention be limited not by this specific disclosure herein, but only by the appended claims.

What is claimed is:

1. A method for incentivizing student achievement, comprising:
maintaining a database of at least one student and at least one attribute of each of said at least one student;
providing teachers access to an online system for providing input on said at least one attribute;
updating the database based on said input from said teachers;
permitting at least one business to offer at least one incentive to the at least one student, wherein each of the at least one student may only utilize each incentive based on a specific attribute specified by said at least one business, the specific attribute being based on said at least one attribute of said at least one student;
maintaining a database of said incentives provided by said at least one business;
enabling each of the at least one student to interact with the database of incentives using the online system and as a result of the interaction, providing a list of the incentives to the at least one student through the online system;
enabling each of the at least one business to interact with the database using the online system and provide an identification of a student seeking an incentive from the at least one business; and
in response to the provided identification, responding to the at least one business, in the affirmative or negative, as to whether a particular student seeking an incentive has the specific attribute for a particular incentive offered by the at least one business.

2. The method of claim 1 wherein the at least one attribute comprises grades.

3. The method of claim 1, further comprising the step of determining a fee to collect from the at least one business based on interaction of the at least one business with the online system and then collecting the determined fee from the at least one business.

4. The method of claim 3, wherein the fee is collected from the at least one business providing incentives.

5. The method of claim 3, wherein the fee is collected from the at least one business based on the use of the incentives provided by the at least one business by the at least one student.

6. The method of claim 1, further comprising:
providing the at least one student with an identification device;
providing the at least one business with a secured data link device capable of interfacing with the identification device and connecting to the online system; and
performing the step of responding to the at least one business only when the particular student's identification device is interfaced with the business's secured data link device.

7. The method of claim 6, wherein the identification device is selected from the group consisting of a card having a magnetic stripe, a card having a barcode, a radio-frequency identification (RFID) transmitter, a near-field communication (NFC) transmitter, and a card having a QR code.

8. The method of claim 6, wherein the identification device provides the student access to an account selected from the group consisting of a credit account, a debit account, and a stored value account.

9. The method of claim 1, further comprising:
maintaining a database of at least one teacher and at least one teacher attribute corresponding to each said at least one teacher;
permitting the at least one business to offer at least one teacher incentive to the at least one teacher, wherein each of the at least one teacher may only utilize each teacher incentive based on a specific teacher attribute specified by said at least one business;
maintaining a database of said teacher incentives provided by said at least one business;
providing a list of the teacher incentives to the at least one teacher through the online system; and
responding to businesses, in the affirmative or negative, when queried by said at least one business as to whether a particular teacher has the specific attribute for a particular incentive.

10. The method of claim 9, wherein at least one teacher attribute corresponding to each of the at least one teacher is derived from the attributes of the students taught by each of the at least one teacher.

11. The method of claim 1, wherein the at least one student comprises a plurality of students, further comprising:
designating a first group of students as mentor candidates based on their attributes;
designating a second group of students as mentee candidates based on their attributes; and
matching, using a processor, at least one mentor candidate with at least one mentee candidate.

12. The method of claim 11, further comprising providing a communication means to the mentor candidate and the mentee candidate matched in the matching step.

13. The method of claim 12, wherein the attributes of the mentor candidates are altered based on changes in the attributes of the mentee candidates matched with said mentor candidates.

14. A student incentive system, comprising:
a student database containing a plurality of student records, each of said student records comprising a student identifier and at least two student attributes, wherein each student identifier identifies a student;
an incentive database containing a plurality of incentive offers, each of said incentive offers comprising an incentive offered by a business and an attribute required for said incentive; and
an online system comprising:
a first interface providing access to the student database;
a second interface providing access to the incentive database; and
a verification interface that, when provided an incentive offer and a student identifier, determines using said first and second interfaces, if the student identified by the student identifier has the attribute required for the incentive of the incentive offer.

15. The system of claim 14, further comprising:
at least one student identifying device provided to each of at least one student and encoding the student identifier identifying said at least one student; and
at least one secured data link device provided to at least one business offering at least one incentive;
said secured data link device being configured to read the student identifier encoded on a student identifying device, connect to the verification interface of the online system, provide the previously read student identifier and at least one incentive offered by the business to the verification interface, and output the response of the verification interface.

16. The system of claim 15, wherein the student identifying device is selected from the group consisting of a card having a magnetic stripe, a card having a barcode, a radio-frequency identification (RFID) transmitter, a near-field communication (NFC) transmitter, and a card having a QR code.

17. The system of claim 14, wherein at least one student attribute is at least one academic grade.

18. The system of claim 15, wherein the student identifying device is also configured to provide the student access to an account selected from the group consisting of a credit account, a debit account, and a stored value account.

19. The system of claim 14, further comprising a mentorship system, said mentorship system comprising:
a mentor candidate selection system that selects students in the student database based on their attributes;
a mentee candidate selection system that selects students in the student database based on their attributes; and
a mentorship matching system coupled to said mentor candidate selection system and said mentee candidate system and that is configures to match mentor candidates and mentee candidates.

20. The system of claim 19, wherein the mentorship system further comprises a communication system that enables communication between mentor candidates and mentee candidates matched by the mentorship matching system.
